(19) United States
(12) Patent Application Publication
(10) Pub. No.: US 2015/0077371 A1
(43) Pub. Date: Mar. 19, 2015

(54) ELECTRONIC DEVICE AND METHOD FOR UNLOCKING THE ELECTRONIC DEVICE

(71) Applicant: FIH (Hong Kong) Limited, Kowloon (HK)

(72) Inventor: WANG-HUNG YEH, New Taipei (TW)

(21) Appl. No.: 14/489,722

(22) Filed: Sep. 18, 2014

(30) Foreign Application Priority Data
Sep. 18, 2013 (TW) 102133761

(51) Int. Cl. G06F 3/041; G06F 3/0481; G06F 3/0488; G06F 3/0484

(52) U.S. Cl. CPC G06F 3/0416; G06F 3/0484; G06F 3/04817; G06F 3/04883
USPC 345/173

(57) ABSTRACT

A method for unlocking an electronic device displays an unlocking interface on a touch screen of the electronic device, and detects unlocking touch operations of unlocking the electronic device on the unlocking interface. A touch time duration corresponding to each of the unlocking touch operations is determined, and a password corresponding to each of the unlocking touch operations is recorded according to the confirmed touch time duration. An unlocking mode is confirmed according to the recorded password of each of the unlocking touch operations and a touch sequence of the unlocking touch operations. If the unlocking mode matches the locking mode prestored in a storage device, the electronic device is unlocked.

### CROSS-REFERENCE TO RELATED APPLICATIONS

This application claims priority to Taiwan Patent Application No. 102133761 filed on Sep. 18, 2013, the contents of which are incorporated by reference herein.

### FIELD

The subject matter of the present disclosure relates to user interfaces for electronic devices, and particularly to an electronic device and a method for unlocking the electronic device.

### BACKGROUND

Most electronic devices with touch screens (for example, smart phones) may be locked and unlocked using a slide operation on the touch screen. However, the slide operation can easily be observed, and thus data security cannot be ensured.

### BRIEF DESCRIPTION OF THE DRAWINGS

Implementations of the present disclosure will be described, by way of example only, with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a block diagram of one embodiment of an electronic device including an unlocking system.

FIG. 2 is a block diagram of one embodiment of an unlocking system included in the electronic device in FIG. 1.

FIG. 3A, FIG. 3B and FIG. 3C are diagrammatic views of one embodiment of setting the locking mode on a touch screen of the electronic device of FIG. 1.

FIG. 4 is a flowchart of one embodiment of a method of setting a locking mode of the electronic device in FIG. 1.

FIG. 5 is a flowchart of one embodiment of a method for unlocking the electronic device of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references can mean “at least one,” or “one or more. ”

In the present disclosure, “module,” refers to logic embodied in hardware or firmware, or to a collection of software instructions, written in a program language. In one embodiment, the program language can be Java, C, or assembly. One or more software instructions in the modules can be embedded in firmware, such as in an erasable programmable read only memory (EPROM). The modules described herein can be implemented as either software and/or hardware modules and can be stored in any type of non-transitory computer-readable media or storage medium. Non-limiting examples of a non-transitory computer-readable medium include CDs, DVDs, flash memory, and hard disk drives.

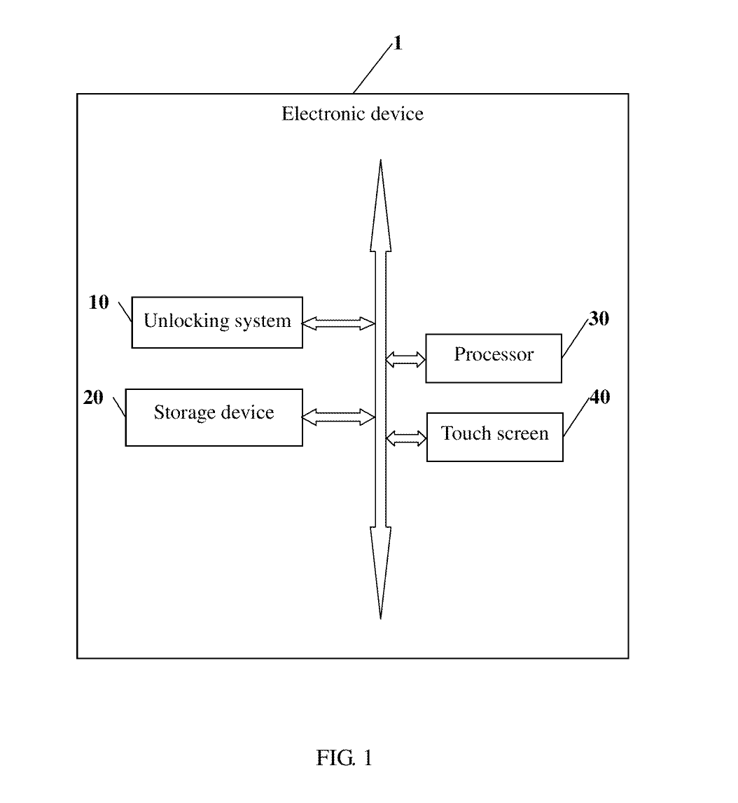

FIG. 1 is a block diagram of one embodiment of an electronic device including an unlocking system. In one embodiment, an electronic device 1 can be a mobile phone, a tablet computer, a notebook computer, or any other electronic device. The electronic device 1 includes, but is not limited to, an unlocking system 10, a storage device 20, at least one processor 30, and a touch screen 40. In one embodiment, the unlocking system 10 can preset a locking mode according to touch operations, and unlock the electronic device 1 when an unlocking mode generated by recognizing the touch operations matches the locking mode.

The at least one processor 30 executes one or more computerized codes and other applications of the electronic device 1 to provide functions of the unlocking system 10. The storage device 20 can be a memory of the electronic device 1 or an external storage card, such as a smart media card or a secure digital card. The touch screen 40 can be a capacitive touch screen, a resistive touch screen or other types of touch screen supporting touch operations (including pressing operations) of a finger or a stylus, for example.

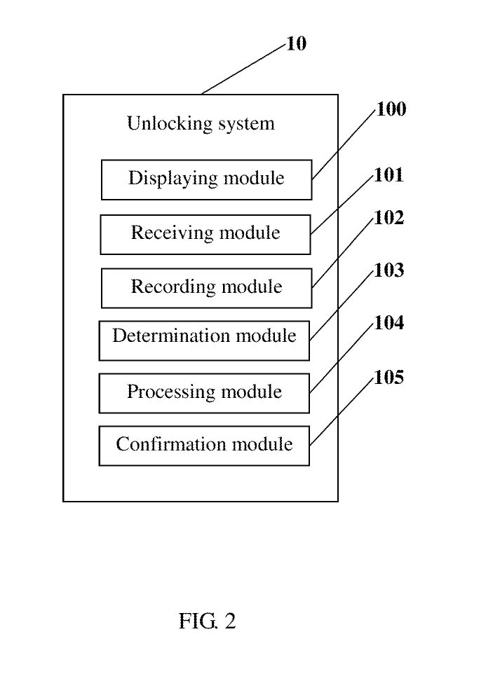

FIG. 2 is a block diagram of one embodiment of an unlocking system included in the electronic device in FIG. 1. In this embodiment, the unlocking system 10 can include a displaying module 100, a detecting module 101, a recording module 102, a determination module 103, a processing module 104, and a confirmation module 105. The modules 100-105 include computerized code in the form of one or more programs that are stored in the storage device 20. The computerized code includes instructions that are executed by the at least one processor 30 to provide functions of the unlocking system 10.

The display module 100 displays an unlocking interface on the touch screen 40 for a user to execute touch operations on the touch screen 40. When the electronic device 1 is required to preset a locking mode, the user can execute touch operations of setting the locking mode (hereinafter referred to as “locking touch operations”) on the touch screen 40. When the electronic device 1 is required to be unlocked, the user can execute touch operations of an unlocking mode (hereinafter referred to as “unlocking touch operations”) on the touch screen 40.

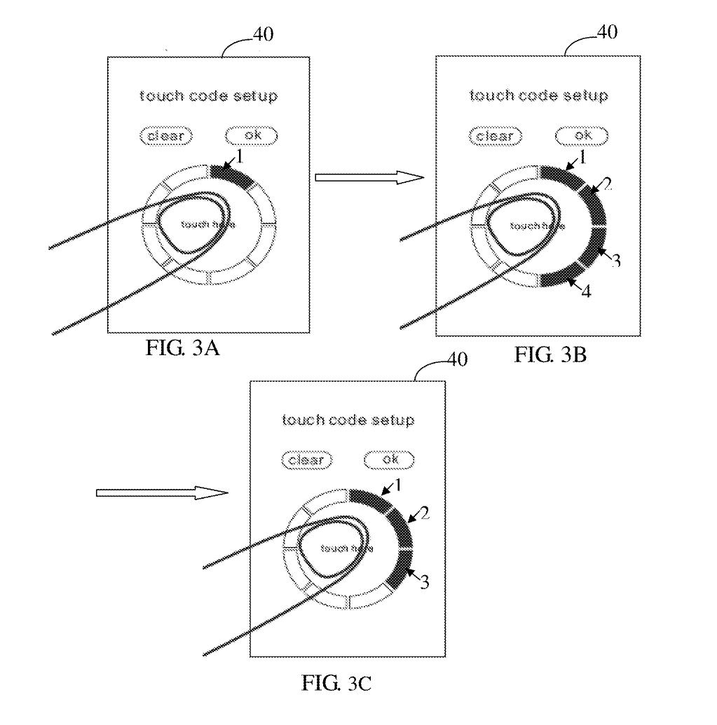

In one embodiment, the unlocking interface can provide a first area for executing the locking/unlocking touch operations and a second area for displaying prompts corresponding to the locking/unlocking touch operations. The second area can include a plurality of virtual icons having preset shapes. For example, each of the virtual icons can be a shape of a sector, a ring, a sphere or a rectangle or any other types of shapes. FIG. 3A, FIG. 3B, and FIG. 3C show diagrammatic views of one embodiment of setting the locking mode on a touch screen of the electronic device of FIG. 1. As shown in FIG. 3A, the virtual icons can form a ring. The first area can be an area which is surrounded by the virtual icons on the touch screen 40, and also can be any other predetermined area on the touch screen 40.

In some embodiments, the virtual icons can be displayed with a first status initially when no touch operation is detected on the first area. After the first area is pressed by a finger or other object (e.g., a stylus) recognized by the touch screen 40, first status of one or more virtual icons corresponding to touch time duration of the touch operation on the first area can be changed to be a second status. For example, the first status of the virtual icons can be a first color or a first color combination, and the second status of the virtual icons can be a second color or a second color combination. In other embodiment, the first status of the virtual icons can be a first shape, and the second status of the virtual icons can be a second shape.

In at least one embodiment, different ranges of the touch time duration can cause different virtual icons to be changed from the first status to the second status. And each virtual icon can correspond to a preset code. When status of one or more virtual icons are changed from the first status to the second status, a password corresponding to the changed virtual icons can be determined according to the preset codes of the changed virtual icons.

In one embodiment, the unlocking interface further includes a first virtual button and a second virtual button. The first virtual button and the second virtual button can be displayed on the unlocking interface when a user presses the first area on the touch screen 40 to preset the locking mode. The first virtual button can trigger a first command, and the second virtual button can trigger a second command. As shown in FIG. 3A, the first virtual button can be a virtual button marked with “clear” and the second virtual button can be a virtual button marked with “ok” in FIG. 3 A.

The detecting module 101 detects the locking/unlocking touch operations of on the first area from the touch screen 40, and confirm touch time duration of each of the locking/unlocking touch operations. When the user use the finger or other tool (e.g., a stylus) to touch the first area on the touch screen 40, the touch time duration is started to time. Once the finger or the other object leaves from the first area, the touch operation is determined to be released and the touch time duration is determined. In one embodiment, after confirming the touch time duration of each of the locking/unlocking touch operations, the detecting module 101 can further change the virtual icons from the first status to be the second status according to the touch time duration, for prompting the password of the touch operation for the user.

For example, as shown in FIG. 3A, touch time duration of a first touch operation on the first area is determined to be 0.5 second, and a virtual icon labeled “1” is changed to be black. In FIG. 3B, touch time duration of a second touch operation on the first area is determined to be 3 seconds, and virtual icons labeled “1”, “2”, “3”, “4” are changed to be black.

In FIG. 3C, touch time duration of a third touch operation on the first area is determined to be 2 seconds, and virtual icons labeled “1”, “2”, “3” are changed to be black.

The recording module 102 records a password corresponding to each of the locking/unlocking touch operations according to the determined touch time duration of each of the locking/unlocking touch operations. For example, as shown in FIG. 3B, if the virtual icons labeled “1”, “2”, “3”, “4” correspond to a preset code of 1, 2, 3, 4 respectively, the recording module 102 can record a password of “1234” corresponding to the second touch operation in FIG. 3B. In one embodiment, when the locking touch operations are executed on the electronic device 1 to preset the locking mode, the recording module 102 records the passwords in a first position of the storage device 20. When the unlocking touch operations are executed on the electronic device 1 to unlock the electronic device 1, the recording module 102 records the passwords in a second position of the storage device 20 temporarily.

During presetting the lock mode, the determination module 103 determines whether the electronic device 1 receives a first command, and further determines whether the electronic device 1 receives a second command. In at least one embodiment, the first command is used to clear the recorded passwords in the first position, and the second command is used to confirm that the locking/unlocking touch operations have been finished. In one embodiment, if the first virtual button is triggered, the determination module 103 determines that the electronic device 1 receives the first command. If the second virtual button is triggered, the determination module 103 determines that the electronic device 1 receives the second command.

If the electronic device 1 receives the first command, the processing module 104 clears the recorded passwords in the first position and prompts the user to execute the locking touch operations again. In one embodiment, the processing module 104 displays a prompt message on the touch screen 40 or output an audio prompt using a speaker of the electronic device 1.

If the electronic device 1 receives the second command, the confirmation module 105 confirms the locking mode by combining the recorded passwords according to a touch sequence of the locking touch operations

During the electronic device 1 executes the unlocking touch operations, the confirmation module 105 confirms the unlocking mode by combining the recorded passwords according to a touch sequence of the unlocking touch operations when the unlocking touch operation for the unlocking mode is determined to be finished. In one embodiment, the unlocking touch operations can be determined to be finished when no more touch operation is detected in a preset time duration (for example, 3 seconds). In other embodiment, the unlocking touch operations can be determined to be finished when a preset finished command is triggered.

The determination module 103 further determines whether the unlocking mode matches the locking mode. For example, when the recorded passwords in the locking mode is identical to the recorded passwords in the unlocking mode, the determination module 103 determines that the unlocking mode matches the locking mode. If the recorded passwords in the locking mode are different from the recorded passwords in the unlocking mode, the determination module 103 determines that the unlocking mode does not match the locking mode.

The processing module 104 unlocks the electronic device 1 when the unlocking mode is determined to match the locking mode.

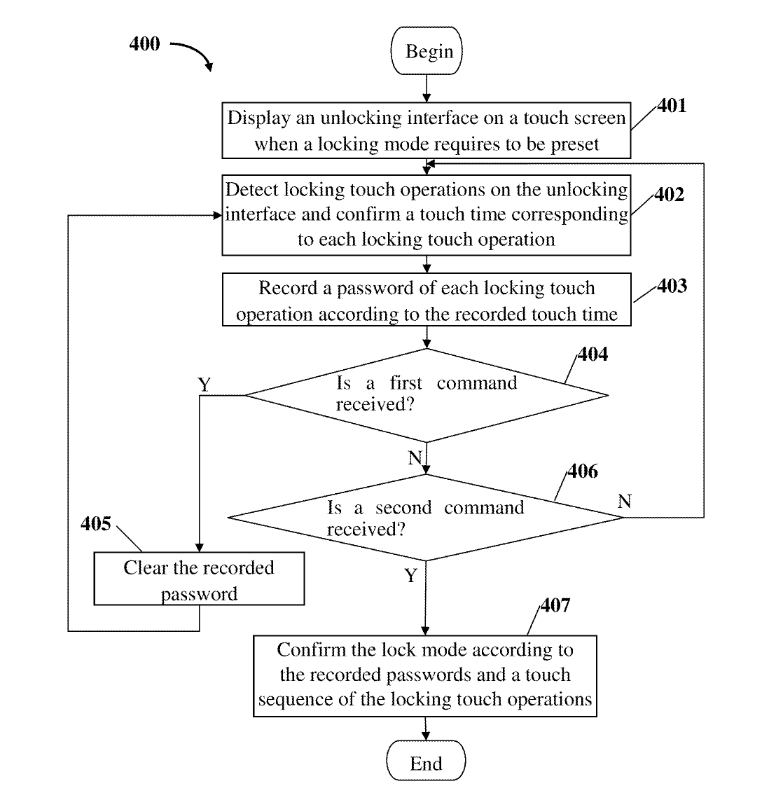

FIG. 4 is a flowchart of one embodiment of a method of setting a locking mode of the electronic device in FIG. 1. Depending on the embodiment, additional blocks can be added, others removed, and the ordering of the blocks can be changed. In the embodiment, the method 400 is performed by execution of computer-readable software program codes or instructions by at least one processor of a computing device. The method 400 is provided by way of example, as there are a variety of ways to carry out the method. The method 400 described below can be carried out using the configurations illustrated in FIG. 1-FIG. 2, for example, and various elements of these figures are referenced in explaining method 400. Each block shown in FIG. 4 represents one or more processes, methods or subroutines, carried out in the method 400. Additionally, the illustrated order of blocks is by example only and the order of the blocks can change according to the present disclosure. The example method 400 can begin at block 401.

In block 401, when the electronic device 1 requires to preset a locking mode for locking the electronic device 1, the display module displays an unlocking interface on the touch screen 40 for a user to execute locking touch operations on the touch screen 40. In one embodiment, the unlocking interface can include a first area for executing the touch operations and a second area including a plurality of virtual icons initially displayed with a first status.

In block 402, the detecting module detects the locking touch operation of the locking mode on the first area from the touch screen 40, and confirms a touch time duration of each of the lucking touch operations. In one embodiment, after confirming the touch time duration of each of the lucking touch operations, the detecting module further changes the virtual icons on the unlocking interface from the first status to the second status according to the touch time duration.

In block 403, the recording module records a password corresponding to each of the locking touch operations in a first position of the storage device 20.

In block 404, the determination module determines whether the electronic device 1 receives a first command. In one embodiment, if a first virtual button in the unlocking interface is triggered, the determination module determines that the electronic device receives the first command. If the determination module determines that the electronic device 1 receives the first command, block 405 is implemented. If the determination module determines that the electronic device 1 does not receive the first command, block 406 is implemented.

In block 405, the processing module clears the recorded passwords in the first position and prompts the user to execute the locking touch operations of setting the locking mode newly, and block 402 is implemented.

In block 406, the determination module determines whether the electronic device 1 receives a second command. In one embodiment, if a second virtual button in the unlocking interface is triggered, the determination module determines that the electronic device receives the second command. If the determination module determines that the electronic device 1 receives the second command, block 407 is implemented. If the determination module determines that the electronic device 1 does not receive the second command, block 402 is implemented to receive a next locking touch operation.

In block 407, the confirmation module confirms the locking mode by combining the recorded passwords in the first position according to a touch sequence of the locking touch operations.

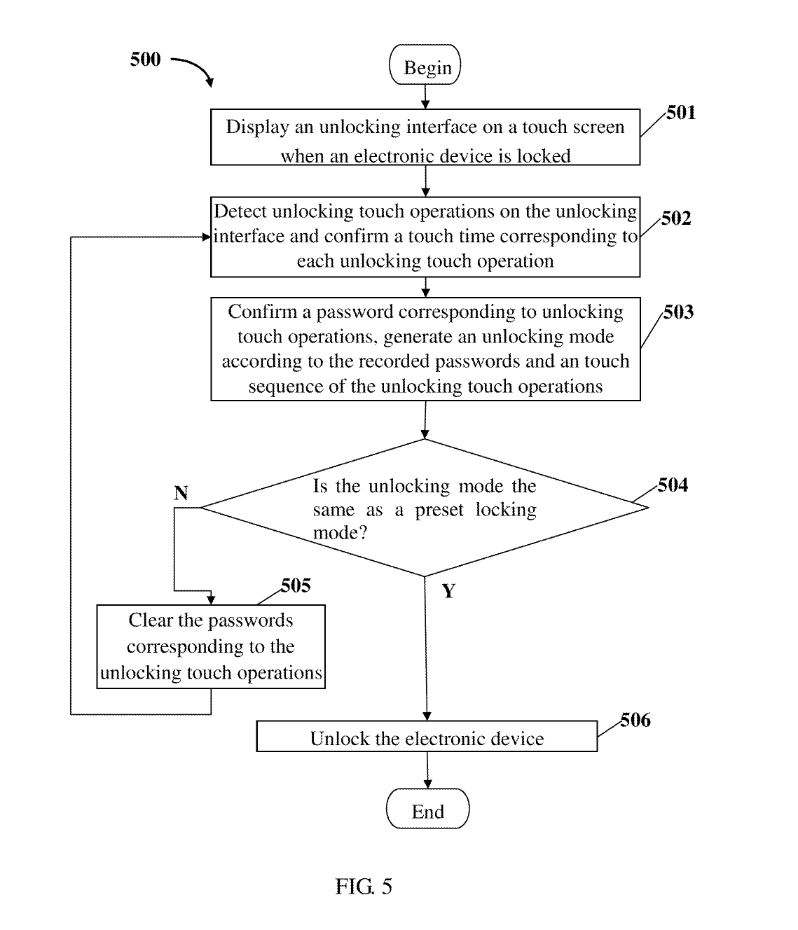

FIG. 5 is a flowchart of one embodiment of a method for unlocking the electronic device of FIG. 1. Depending on the embodiment, additional blocks can be added, others removed, and the ordering of the blocks can be changed. In the embodiment, the method 500 is performed by execution of computer-readable software program codes or instructions by at least one processor of a computing device. The method 500 is provided by way of example, as there are a variety of ways to carry out the method. The method 500 described below can be carried out using the configurations illustrated in FIG. 1-FIG. 2, for example, and various elements of these figures are referenced in explaining method 500. Each block shown in FIG. 5 represents one or more processes, methods or subroutines, carried out in the method 500. Additionally, the illustrated order of blocks is by example only and the order of the blocks can change according to the present disclosure. The example method 500 can begin at block 501.

In block 501, when the electronic device 1 requires to unlock the electronic device 1, the display module displays the unlocking interface on the touch screen 40 for users to execute the unlocking touch operations of unlocking the electronic device 1.

In block 502, the detecting module detects the unlocking touch operations on the first area from the touch screen 40, and confirms a touch time duration corresponding to each of the unlocking touch operations of the unlocking mode. In one embodiment, after confirming the touch time duration corresponding to each of the unlocking touch operations, the detecting module further changes the virtual icons on the unlocking interface from the first status to the second status according to the confirmed touch time duration.

In block 503, the recording module records a password corresponding to each of the unlocking touch operations in a second position of the storage device 20, and the confirmation module confirms the unlocking mode by combining the recorded passwords according to a touch sequence of the unlocking touch operations when the unlocking touch operation for the unlocking mode is determined to be finished.

In block 504, the determination module determines whether the unlocking mode matches the locking mode. When the recorded passwords in the locking mode is identical to the recorded passwords in the unlocking mode, the determination module 103 determines that the unlocking mode matches the locking mode, and block 506 is implemented. If the recorded passwords in the locking mode are different from the recorded passwords in the unlocking mode, the determination module 103 determines that the unlocking mode does not match the locking mode, and block 505 is implemented.

In block 505, the processing module clears the recorded passwords in the second position and prompts the user to execute the unlocking touch operations for unlocking the electronic device 1 newly, and block 502 is implemented.

In block 506, the processing module unlocks the electronic device 1, and the procedure ends.

All of the processes described above may be embodied in, and fully automated via, functional code modules executed by one or more general purpose processors such as the processor 30. The code modules may be stored in any type of non-transitory readable medium or other storage device such as the storage device 20. Some or all of the methods may alternatively be embodied in specialized hardware. Depending on the embodiment, the non-transitory readable medium can be a hard disk drive, a compact disc, a digital versatile disc, a tape drive, or other storage medium.

The described embodiments are merely examples of implementations, and have been set forth for a clear understanding of the principles of the present disclosure. Variations and modifications may be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. A computer-implemented method for unlocking an electronic device, the method comprising:
displaying an unlocking interface on a touch screen of the electronic device;
detecting unlocking touch operations on the unlocking interface;
confirming a touch time duration corresponding to each of the unlocking touch operations;
recording a password corresponding to each of the unlocking touch operations according to the touch time duration;
confirming an unlocking mode according to the password of each of the unlocking touch operations and a touch sequence of the unlocking touch operations; and
unlocking the electronic device when the unlocking mode matches a locking mode prestored in a storage device of the electronic device.

2. The method according to claim 1, wherein the locking mode is prestored by:
displaying the unlocking interface on the touch screen when the electronic device starts to preset the locking mode;
detecting locking touch operations of presetting the locking mode;
confirming a touch time duration corresponding to each of the locking touch operations;
recording a password corresponding to each of the locking touch operations of the electronic device according to the confirmed touch time duration;
determining whether the electronic device receives a first command;
clearing the recorded password when the electronic device receives the first command, and returning to the step of detecting the locking touch operations of presetting the locking mode;
determining whether the electronic device receives a second command when the electronic device does not receive the first command; and
confirming a locking mode according to the recorded password of each of the unlocking touch operations and a touch sequence of the locking touch operations when the electronic device receives the second command.

3. The method according to claim 2, wherein the unlocking interface comprises a first virtual button to trigger the first command and a second virtual button to trigger the second command, the first virtual button and the second virtual button are displayed on the unlocking interface when a first area on the touch screen is pressed to preset the locking mode.

4. The method according to claim 2, wherein the unlocking interface comprises a first area for executing the touch operations and a second area for displaying prompts corresponding to the touch operations, and the second area comprises a plurality of virtual icons, the plurality of virtual icons being displayed with a first status when no touch operation is detected on the first area, and different ranges of the touch time duration can cause different virtual icons to be changed from the first status to the second status.

5. The method according to claim 4, wherein the first status of the virtual icons comprises a first color, a first color combination, and/or a first shape, and the second status of the virtual icons comprises a second color, a second color combination, and/or a second shape.

6. The method according to claim 1, further comprising:
clearing the recorded passwords in the storage device and prompting the user to execute the locking touch operations again for setting the locking mode, when the locking mode does not match the unlocking mode.

7. A non-transitory storage medium storing a set of instructions, when executed by at least one processor of an electronic device, cause the at least one processor to perform a method for unlocking the electronic device, the method comprising:
displaying an unlocking interface on a touch screen of the electronic device;
detecting unlocking touch operations of unlocking the electronic device on the unlocking interface, and confirming a touch time duration corresponding to each of the unlocking touch operations;
recording a password corresponding to each of the unlocking touch operations according to the confirmed touch time duration;
confirming an unlocking mode according to the recorded password of each of the unlocking touch operations and a touch sequence of the unlocking touch operations; and
unlocking the electronic device when the unlocking mode matches a locking mode prestored in a storage device of the electronic device.

8. The storage medium according to claim 7, wherein the locking mode is prestored by:
displaying the unlocking interface on the touch screen when the electronic device starts to preset the locking mode;
detecting locking touch operations of presetting the locking mode;
confirming a touch time duration corresponding to each of the locking touch operations;
recording a password corresponding to each of the locking touch operations of the electronic device according to the confirmed touch time duration;
determining whether the electronic device receives a first command;
clearing the recorded password when the electronic device receives the first command, and returning to the step of detecting the locking touch operations of presetting the locking mode;
determining whether the electronic device receives a second command when the electronic device does not receive the first command; and
confirming a locking mode according to the recorded password of each of the unlocking touch operations and a touch sequence of the locking touch operations when the electronic device receives the second command.

9. The storage medium according to claim 8, wherein the unlocking interface comprises a first virtual button to trigger the first command and a second virtual button to trigger the second command, and the first virtual button and the second virtual button are displayed on the unlocking interface when a first area on the touch screen is pressed to preset the locking mode.

10. The storage medium according to claim 8, wherein the unlocking interface comprises a first area for executing the touch operations and a second area for displaying prompts corresponding to the touch operations, and the second area comprises a plurality of virtual icons, the plurality of virtual icons being displayed with a first status when no touch operation is detected on the first area, and different ranges of the touch time duration can cause different virtual icons to be changed from the first status to the second status.

11. The storage medium according to claim 10, wherein the first status of the virtual icons comprises a first color, a first color combination, and/or a first shape, and the second status of the virtual icons comprises a second color, a second color combination, and/or a second shape.

12. The storage medium according to claim 7, the method further comprises:
clearing the recorded passwords in the storage device and prompting the user to execute the locking touch operations again for setting the locking mode, when the locking mode does not match the unlocking mode.

13. An electronic device, comprising:
a touch screen;
at least one processor; and
a storage device storing one or more programs, which when executed by the at least one processor, cause the at least one processor to:
display an unlocking interface on a touch screen of the electronic device;
detect unlocking touch operations of unlocking the electronic device on the unlocking interface, and confirm a touch time duration corresponding to each of the unlocking touch operations;
record a password corresponding to each of the unlocking touch operations according to the confirmed touch time duration;
confirm an unlocking mode according to the recorded password of each of the unlocking touch operations and a touch sequence of the unlocking touch operations; and
unlock the electronic device when the unlocking mode matches a locking mode prestored in a storage device of the electronic device.

14. The electronic device according to claim 13, wherein the locking mode is prestored by:
displaying the unlocking interface on the touch screen when the electronic device starts to preset the locking mode;
detecting locking touch operations of presetting the locking mode;
confirming a touch time duration corresponding to each of the locking touch operations;
recording a password corresponding to each of the locking touch operations of the electronic device according to the confirmed touch time duration;
determining whether the electronic device receives a first command;
clearing the recorded password when the electronic device receives the first command, and returning to the step of detecting the locking touch operations of presetting the locking mode;
determining whether the electronic device receives a second command when the electronic device does not receive the first command; and
confirming a locking mode according to the recorded password of each of the unlocking touch operations and a touch sequence of the locking touch operations when the electronic device receives the second command.

15. The electronic device according to claim 14, wherein the unlocking interface comprises a first virtual button to trigger the first command and a second virtual button to trigger the second command, and the first virtual button and the second virtual button are displayed on the unlocking interface when a first area on the touch screen is pressed to preset the locking mode.

16. The electronic device according to claim 14, wherein the unlocking interface comprises a first area for executing the touch operations and a second area for displaying prompts corresponding to the touch operations, and the second area comprises a plurality of virtual icons, the plurality of virtual icons being displayed with a first status when no touch operation is detected on the first area, and different ranges of the touch time duration can cause different virtual icons to be changed from the first status to the second status.

17. The electronic device according to claim 16, wherein the first status of the virtual icons comprises a first color, a first color combination, and/or a first shape, and the second status of the virtual icons comprises a second color, a second color combination, and/or a second shape.

18. The electronic device according to claim 13, wherein the at least one processer further clears the recorded passwords in the storage device and prompts the user to execute the locking touch operations again for setting the locking mode, when the locking mode does not match the unlocking mode.
